(19) United States
(12) Patent Application Publication
(10) Pub. No.: US 2025/0147201 A1
(43) Pub. Date: May 8, 2025

(54) QUANTITATIVE SIMULATION METHOD FOR CONTRIBUTIONS OF THREE ORIGINS OF OVERPRESSURE IN SANDSTONE

(71) Applicants: Northeast Petroleum University, Daqing City (CN); China University of Petroleum (East China), Huangdao District (CN)

(72) Inventors: Wenguang WANG, Daqing City (CN); Chengyan LIN, Daqing City (CN); Xiaofei FU, Daqing City (CN); Min WANG, Daqing City (CN); Yan ZHANG, Daqing City (CN); Huiting HU, Daqing City (CN); Haixue WANG, Daqing City (CN); Chao LIU, Daqing City (CN); Shansi TIAN, Daqing City (CN); Jinfeng ZHANG, Daqing City (CN); Likai CUI, Daqing City (CN); Zhida LIU, Daqing City (CN); Yerejiepu HABULASHENMU, Daqing City (CN)

(21) Appl. No.: 18/911,639

(22) Filed: Oct. 10, 2024

(30) Foreign Application Priority Data
Nov. 2, 2023 (CN) 202311453776.4

(51) Int. Cl. G01V 20/00; E21B 49/00

(52) U.S. Cl. CPC G01V 20/00; E21B 49/00; E21B 2200/20

(57) ABSTRACT

A quantitative simulation method for contributions of three origin of overpressure in sandstone is provided. Analytical testing data, well logging data, geological data, seismic data, and the like are collected and collated. A formation pressure characteristic of sandstone of a target horizon is analyzed and a burial history and a thermal history of the sandstone of the target horizon is reconstructed. An undercompacted pore pressure evolution history and an undercompacted hydrocarbon generation pressurized pore pressure evolution history, and a total pore pressure evolution history is quantitatively simulated. A quantitative analysis is performed on contributions of three origin of overpressure: quantitatively analyzing contributions of undercompaction, pressurization by hydrocarbon generation, and other origin to overpressure according to Pₜₒₜₐₗ=P_{underc}+P_{hydrog} and Pₜₒₜₐₗ=P_{underc}+P_{hydrog}+Pₜₒₜₐₗ to obtain overpressure evolution mechanisms of three origins. The contributions of the origins of overpressure in the sandstone are quantitatively simulated, and a geological exploration region of an oil and gas reservoir is determined.

### CROSS REFERENCE TO RELATED APPLICATION

This patent application claims the benefit and priority of Chinese Patent Application No. 202311453776.4, filed with the China National Intellectual Property Administration on Nov. 2, 2023, the disclosure of which is incorporated by reference herein in its entirety as part of the present application.

### TECHNICAL FIELD

The present disclosure relates to the technical field of geological exploration of oil and gas reservoirs, and in particular, to a quantitative simulation method for contributions of three origin of overpressure in sandstone.

### BACKGROUND

The understanding and prediction of a subsurface pressure may be vital in various aspects of upstream activities such as exploration, well drilling, and production. Overpressure is the result of a formation fluid being unable to escape at such a velocity that a balance between the formation fluid and a formation water column existing in the earth's surface is kept. Overpressure refers to a pore-fluid pressure being higher than a hydrostatic pressure, and an upper limit thereof is a formation fracture pressure. A formation under a normal pressure has the characteristics of a high total body density, a high compaction percentage, and a high effective stress, and a highly overpressured formation has the characteristics of a high porosity, a high pore pressure, and a high formation temperature (Dutta, 2002). There are many mechanisms for explaining the high-pressure phenomena occurring in sedimentary basins, mainly including (1) an abnormal high pressure produced by undercompaction, (2) an abnormal high pressure created by large-scale tectonic compression, (3) an abnormal high pressure produced by aquathermal pressuring, (4) an abnormal high pressure caused by a dehydration reaction related to the diagenesis of minerals, and (5) an abnormal high pressure caused by a pore fluid volume increase due to kerogenic thermomaturation. Global overpressure existence is usually related to the following factors: tertiary basin, rapid deposition and sedimentation, and compressive tectonic activity.

The causes of overpressure include mechanical compaction, chemical compaction, overpressure caused by hydrocarbon generation, thermal expansion, mineral dehydration, and montmorillonite-illite transition. Scholars have previously conducted a lot of studies on overpressure, such as calculation of formation overpressure originated from undercompaction, prediction of formation overpressure originated from hydrocarbon generation from organic matter, prediction of formation overpressure originated from a combination of undercompaction and hydrocarbon generation, calculation of contribution ratios of two pressure origins to overpressure, evaluation of overpressure caused by undercompaction and fluid expansion, etc. However, these quantitative characterization methods for overpressure in sandstone take into account evaluation with respect to one or two overpressure mechanisms. Studies on a mechanism and contribution of an origin of overpressure in a numerical simulation method are not considered. When contributions of three origin of overpressure in a formation are analyzed, contributions of a plurality of origins cannot be evaluated effectively. Therefore, it is necessary to explore a quantitative analysis process for contributions of three origin of overpressure in sandstone based on a numerical simulation method.

### SUMMARY

An objective of the present disclosure is to provide a quantitative simulation method for contributions of three origin of overpressure in sandstone to address a problem of unclear characterization of contributions of origins of overpressure to formation overpressure by undercompaction and hydrocarbon generation prediction models.

The technical solution adopted in the present disclosure to solve the technical problem thereof is as follows: a quantitative simulation method for contributions of three origin of overpressure in sandstone includes the following steps:
Step 1), collecting analytical testing data, well logging data, geological data, and seismic data of sandstone of a target horizon, where the analytical testing data includes conventional core analysis, cast thin section, and scanning electron microscope image data, and organic geochemical data; and the geological data includes well drilling stratification data, formation pressure data, formation temperature data, vitrinite reflectance, and stratigraphic time data;
Step 2), establishing a formation pressure profile according to the formation pressure data, analyzing a formation pressure characteristic of the sandstone of the target horizon in a target region, and establishing a numerical model of pressure simulation, where the numerical model of pressure simulation is established based on an actual formation characteristic and actual geological data of the target horizon and relates to a burial history, a thermal history, and a pressure history;
Step 3), burial history reconstruction: establishing a one-dimensional burial history of the sandstone of the target horizon based on geological stratification, the formation age data, and a period and a thickness of denudation;
Step 4), thermal history reconstruction: implanting the formation temperature data and geothermal gradient data of the sandstone of the target horizon into the numerical model of pressure simulation to reconstruct the thermal history of the sandstone of the target horizon; and when a simulated formation temperature value is consistent with a measured formation temperature value, indicating that the reconstructed thermal history is accurate;
Step 5), quantitatively simulating an undercompacted pore pressure evolution history;
Step 6), quantitatively simulating an undercompacted and hydrocarbon generation pressurized pore pressure evolution history;
Step 7), quantitatively simulating a total pore pressure evolution history; and
Step 8), quantitative analysis of contributions of three origin of overpressure: when the total pore pressure evolution history is greater than the undercompacted and hydrocarbon generation pressurized pore pressure evolution history, the overpressure in the sandstone of the target horizon being contributed by undercompaction, pressurization by hydrocarbon generation, and a third origin, and quantitatively analyzing contributions of the undercompaction, the pressurization by hydrocarbon generation, and the third origin to total overpressure; and when the total pore pressure evolution history is equal to the undercompacted and hydrocarbon generation pressurized pore pressure evolution history, the overpressure in the sandstone of the target horizon being contributed by two origins, namely undercompaction and pressurization by hydrocarbon generation, and quantitatively analyzing contributions of the undercompaction and the pressurization by hydrocarbon generation to total overpressure.

In the above solution, the quantitatively simulating an undercompacted pore pressure evolution history may include: statistically analyzing distribution ranges and average values of porosities and permeabilities of the sandstone of the target horizon and an overlying stratum based on the conventional core analysis data; inputting the porosity and the permeability of the sandstone of the target horizon to the numerical model of pressure simulation to determine the porosity and the permeability of the overlying stratum, and quantitatively simulating the undercompacted pore pressure evolution history.

In the above solution, the quantitatively simulating an undercompacted pore pressure evolution history may include determining a petroleum system in which the sandstone of the target horizon is located according to the burial history and the thermal history of the sandstone of the target horizon, where the petroleum system includes hydrocarbon source rock, a reservoir stratum, and an overlying stratum.

It may further include subtly plotting a porosity-depth relationship plate and a porosity-permeability relationship plate of the sandstone of the target horizon and a plurality of overlying strata, and implanting the two plates into the numerical model of pressure simulation as constraint conditions to quantitatively simulate the undercompacted pore pressure evolution history of the sandstone of the target horizon.

In the above solution, the quantitatively simulating an undercompacted and hydrocarbon generation pressurized pore pressure evolution history may include investigating a kerogen type of underlying hydrocarbon source rock of the sandstone of the target horizon, and organic carbon and original hydrocarbon generation potentials based on the organic geochemical data. On the basis of quantitatively simulating the undercompacted pore pressure evolution history. The kerogen type of the underlying hydrocarbon source rock of the sandstone of the target horizon is determined, and an average value of the organic carbon and original hydrocarbon generation potentials and vitrinite reflectance data of the hydrocarbon source rock is input to the numerical model of pressure simulation; when a simulated vitrinite reflectance value is consistent with a measured vitrinite reflectance data, indicating that the undercompacted and hydrocarbon generation pressurized pore pressure evolution history quantitatively simulated is accurate.

The undercompacted pore pressure evolution history and the undercompacted and hydrocarbon generation pressurized pore pressure evolution history are combined to obtain a hydrocarbon generation pressurized pore pressure evolution history;

$${P}_{hydrog} = {P}_{undecr + hydrog} - {P}_{underc}$$

where P_{underc+hydrog} refers to an undercompacted and hydrocarbon generation pressurized pore pressure; P_{underc} refers to an undercompacted pore pressure; and P_{hydrog} refers to a hydrocarbon generation pressurized pore pressure.

In the above solution, the quantitatively simulating a total pore pressure evolution history may include analyzing the formation pressure characteristic of the sandstone of the target horizon based on measured formation pressure data, and on the basis of quantitatively simulating the undercompacted and hydrocarbon generation pressurized pore pressure evolution history, correcting simulated formation pressure data with the measured formation pressure data. When a measured formation pressure value is consistent with a simulated formation pressure value, quantitatively simulating the total pore pressure evolution history; and evaluating a pore pressure of other origin based on the undercompacted and hydrocarbon generation pressurized pore pressure evolution history and the total pore pressure evolution history;

$${P}_{other} = {P}_{total} - {P}_{underc + hydrog}$$

where P_{underc+hydrog} refers to the undercompacted and hydrocarbon generation pressurized pore pressure; Pₜₒₜₐₗ refers to a total pore pressure; and Pother refers to the pore pressure of other origin.

In the above, the quantitatively simulating an undercompacted and hydrocarbon generation pressurized pore pressure evolution history may include: quantitative analysis of contributions of three origin of overpressure.

The quantitative analysis of contributions of three origin of overpressure may include combining the undercompacted pore pressure evolution history (P_{underc}), the undercompacted and hydrocarbon generation pressurized pore pressure evolution history (P_{hydrog}), and the total pore pressure evolution history (Pₜₒₜₐₗ). When the total pore pressure evolution history is equal to the undercompacted and hydrocarbon generation pressurized pore pressure evolution history, the overpressure in the sandstone of the target horizon is contributed by two origins, namely the undercompaction and the pressurization by hydrocarbon generation. The undercompacted pore pressure evolution history and the undercompacted and hydrocarbon generation pressurized pore pressure evolution history are combined to quantitatively analyze contributions of the undercompaction (P_{underc}) and the pressurization by hydrocarbon generation (P_{hydrog}) to the total overpressure (Pₜₒₜₐₗ);

$${P}_{total} = {P}_{underc} + {P}_{hydrog}$$

where Pₜₒₜₐₗ refers to the total pore pressure; P_{underc} refers to the undercompacted pore pressure; and P_{hydrog} refers to the hydrocarbon generation pressurized pore pressure.

When the total pore pressure evolution history is greater than the undercompacted and hydrocarbon generation pressurized pore pressure evolution history, the overpressure in the sandstone of the target horizon is contributed by the undercompaction, the pressurization by hydrocarbon generation, and other origin; and the undercompacted pore pressure evolution history, the undercompacted and hydrocarbon generation pressurized pore pressure evolution history, and the total pore pressure evolution history are combined to quantitatively analyze contributions of the undercompaction (P_{underc}), the pressurization by hydrocarbon generation (P_{hydrog}), and other origin (Pother) to the total overpressure (Pₜₒₜₐₗ);

$${P}_{total} = {P}_{underc} + {P}_{hydrog} + {P}_{other}$$

where Pₜₒₜₐₗ refers to the total pore pressure; P_{underc} refers to the undercompacted pore pressure; P_{hydrog} refers to the hydrocarbon generation pressurized pore pressure; and Pother refers to the pore pressure of other origin.

Innovatively, the present disclosure quantitatively simulates contributions of three origin of overpressure in sandstone, and quantitatively analyzes contributions of three origins of overpressure. Moreover, regional tentonic characteristics, geological data, and seismic data of a research region may be combined to determine a specific origin mechanism of a pore pressure of other origin.

The present disclosure has the following beneficial effects:
1. The present disclosure is implemented with a formation pressure characteristic, and by burial history-thermal history reconstruction, quantitative simulation of an undercompacted pore pressure evolution history, quantitative simulation of an undercompacted and hydrocarbon generation pressurized pore pressure evolution history, quantitative simulation of a total pore pressure evolution history, and quantitative analysis of contributions of three origin of overpressure. Thus, the contributions of the origins of overpressure in sandstone are quantitatively simulated, and a geological exploration region of an oil and gas reservoir is determined.
2. The present disclosure achieves innovations on techniques of numerical simulation of overpressure and analysis of a formation overpressure mechanism, and takes analytical testing data, well logging data, geological data, seismic data, and the like into overall consideration. A quantitative simulation method for contributions of three origin of overpressure in sandstone is proposed. A multi-stage overpressure evolution mechanism is proposed. The theoretical knowledge of an overpressure origin mechanism is perfected. A numerical simulation method is applied to the technical field of analysis of the overpressure origin mechanism. The contribution of the origin of overpressure can be quantitatively analyzed by the numerical simulation method, and according to requirements of oil field researchers; numerical simulation research is conducted on overpressure in sandstone of a target horizon in terms of a sands group/single layer. The method is scientific and universal.
3. The present disclosure proposes a quantitative analysis process for contributions of three origin of overpressure in sandstone based on a numerical simulation method, which may well provide service support for subsurface pressure condition and overpressure origin mechanism evaluation of a geological exploration region of an oil and gas reservoir.
4. The present disclosure has the characteristics of feasible operation, good evaluation effect, solving a practical problem, and has the following innovations: 1) analyzing a formation pressure characteristic of sandstone of a target horizon; 2) reconstructing a burial history-thermal history of the sandstone of the target horizon; 3) quantitatively simulating an undercompacted pore pressure evolution history; 4) quantitatively simulating an undercompacted and hydrocarbon generation pressurized pore pressure evolution history; 5) quantitatively simulating a total pore pressure evolution history; and 6) quantitatively analyzing contributions of three origin of overpressure. The method meets requirements of current geological exploration of oil and gas reservoirs are met, and is of guiding significance for quantitative analysis on contributions of origins of overpressure in sandstone and exploration work of oil and gas reservoirs.
5. The present disclosure achieves quantitative analysis on a formation pressure characteristic of sandstone of a target horizon, burial history-thermal history reconstruction, an undercompacted pore pressure evolution history, an undercompacted and hydrocarbon generation pressurized pore pressure evolution history, a total pore pressure evolution history, and contributions of three origin of overpressure based on analytical testing data, well logging data, geological data, seismic data, and the like, and proposes a quantitative analysis method for contributions of three origin of overpressure in sandstone.
6. The present disclosure takes into account a formation pressure characteristic, an undercompacted pore pressure evolution history, an undercompacted and hydrocarbon generation pressurized pore pressure evolution history, and a total pore pressure evolution history, and quantitatively analyzes contributions of three origin of overpressure in sandstone. A burial history-thermal history of the sandstone of a target horizon is reconstructed based on geological stratification, formation age data, a period and a thickness of denudation, and formation temperature data. Porosity and permeability values of the sandstone of the target horizon and an overlying stratum, a kerogen type of underlying hydrocarbon source rock, organic carbon and original hydrocarbon generation potentials, and a formation pressure profile are prepared based on conventional core analysis data, organic geochemical data, and measured formation pressure data. These parameters may provide key parameters for numerical simulation research of overpressure. Requirements of quantitative analysis on an overpressure origin mechanism of sandstone of a geological exploration region of an oil and gas reservoir are met. The overpressure evolution histories of the sandstone and evolution mechanisms of three overpressure origins are quantitatively simulated. Theoretical basis is provided for analysis of overpressure origin mechanisms of the sandstone of the geological exploration region of the oil and gas reservoir.
7. The present disclosure proposes a quantitative simulation method for contributions of three origin of overpressure in sandstone. An undercompacted pore pressure evolution history, an undercompacted and hydrocarbon generation pressurized pore pressure evolution history, and a total pore pressure evolution history are quantitatively simulated on the basis of an accurate burial history-thermal history, and contributions of undercompaction, pressurization by hydrocarbon generation, and other origins to total overpressure are quantitatively evaluated. Thus, the contributions of the origins of overpressure in sandstone are quantitatively simulated.

### BRIEF DESCRIPTION OF THE DRAWINGS

FIG. 1 is a flowchart according to the present disclosure;

FIG. 2 is a profile of a measured reservoir temperature and depth of sandstone of a target horizon in XX basin;

FIG. 3 is a profile of a measured formation pressure and depth of sandstone of a target horizon in XX basin;

FIG. 4 illustrates a burial history of sandstone of Huangliu formation of XX1 well in XX basin;

FIG. 5 is a comparison chart of a measured temperature value and a simulated temperature value of sandstone of Huangliu formation of XX1 well in XX basin;

FIG. 6 illustrates an undercompacted pore pressure evolution history of sandstone of a target horizon in XX basin;

FIG. 7 illustrates a kerogen type of underlying hydrocarbon source rock in XX basin;

FIG. 8 illustrates an undercompacted and hydrocarbon generation pressurized pore pressure evolution history of sandstone of Huangliu formation of XX1 well in XX basin;

FIG. 9 illustrates a total pore pressure evolution history of sandstone of Huangliu formation of XX1 well in XX basin;

FIG. 10 is a comparison chart of measured pressure data and simulated pressure data of sandstone of Huangliu formation of XX1 well in XX basin;

FIG. 11 is a comparison chart of three origins of overpressure;

FIG. 12 is a histogram of contribution ratios of three origins of overpressure to overpressure in sandstone; and

FIG. 13 is a diagram of a numerical model of pressure simulation.

### DETAILED DESCRIPTION OF THE EMBODIMENTS

The present disclosure will be explained in detail below with reference to the accompanying drawings.

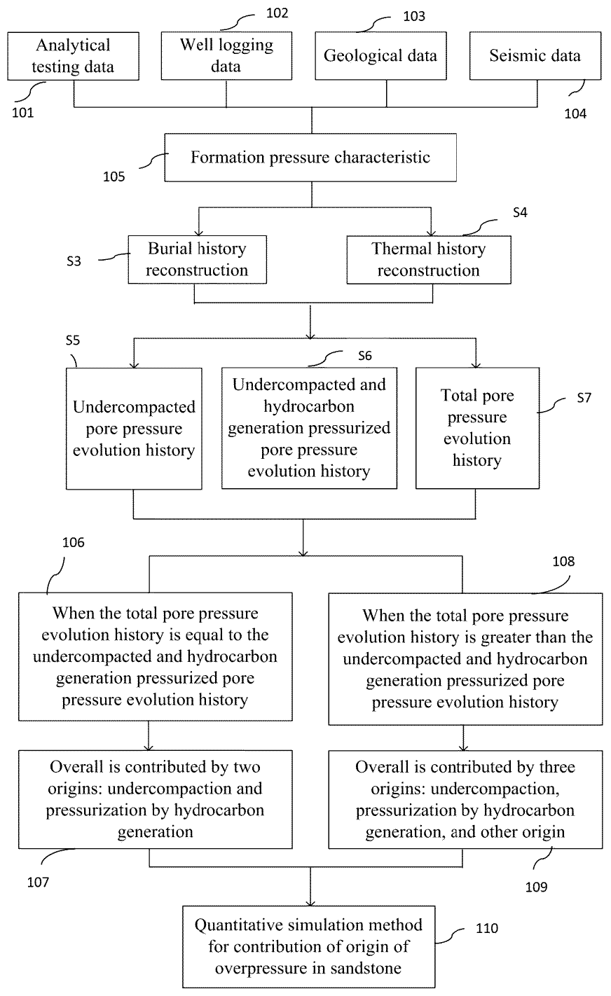

A quantitative simulation method for contributions of three origin of overpressure in sandstone is as follows. Analytical testing data, well logging data, geological data, seismic data, and the like are collected and collated. A formation pressure characteristic of sandstone of a target horizon is analyzed. A burial history and a thermal history of the sandstone of the target horizon are reconstructed. An undercompacted pore pressure evolution history, an undercompacted and hydrocarbon generation pressurized pore pressure evolution history, and a total pore pressure evolution history of sandstone of the target horizon are quantitatively analyzed. On this basis, contributions of undercompaction, pressurization by hydrocarbon generation, and other origin to overpressure are quantitatively analyzed, and overpressure evolution mechanisms of three origins are investigated. As shown in FIG. 1 to FIG. 13, specific steps are as follows.

In step 1), analytical testing data 101, well logging data 102, geological data 103, and seismic data 104 of sandstone of a target horizon are collected, where the analytical testing data includes conventional core analysis, cast thin section, and scanning electron microscope image data, and organic geochemical data; and the geological data includes well drilling stratification data, formation pressure data, formation temperature data, vitrinite reflectance, and stratigraphic time data.

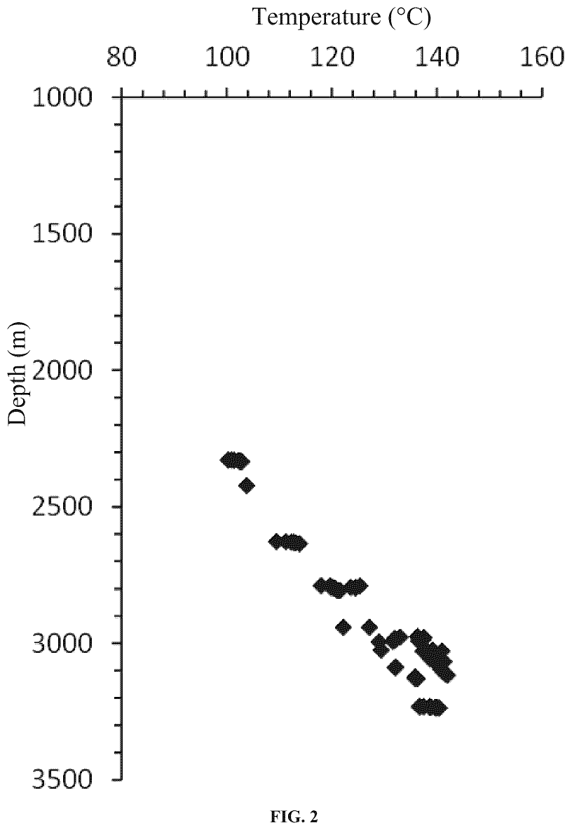

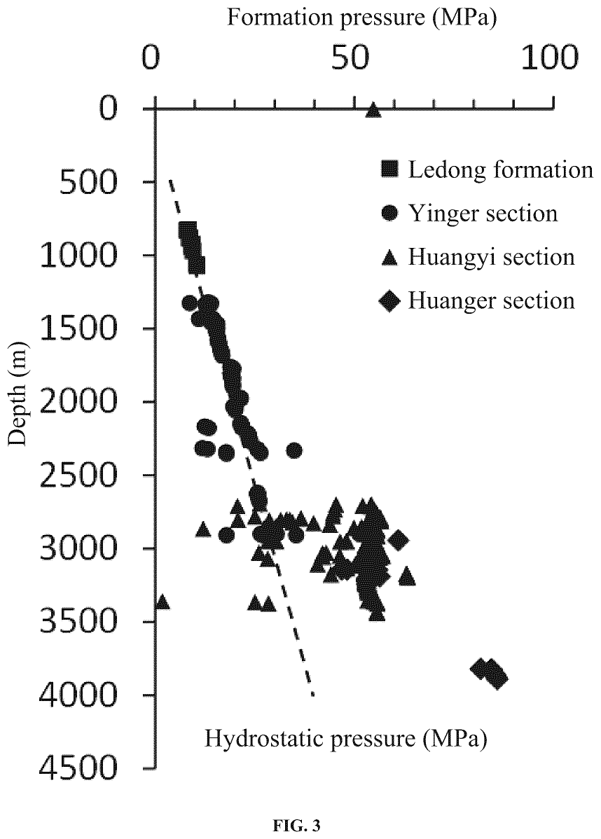

In step 2), a formation pressure profile is established according to the formation pressure data; a formation pressure characteristic 105 of the sandstone of the target horizon in a target region is analyzed, and a numerical model of pressure simulation is established, where the numerical model of pressure simulation is established based on an actual formation characteristic and actual geological data of the target horizon and relates to a burial history, a thermal history, and a pressure history (FIG. 1, FIG. 2, and FIG. 3).

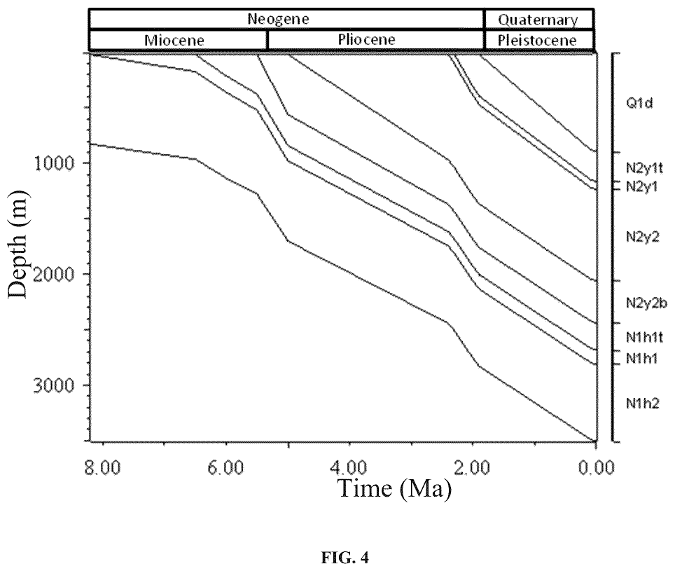

In step 3), burial history reconstruction S3: a one-dimensional burial history of the sandstone of the target horizon is established based on geological stratification, the formation age data, and a period and a thickness 111 of denudation (FIG. 4). The burial history can well reflect a burial process and tectonic evolution stages of the sandstone of the target horizon.

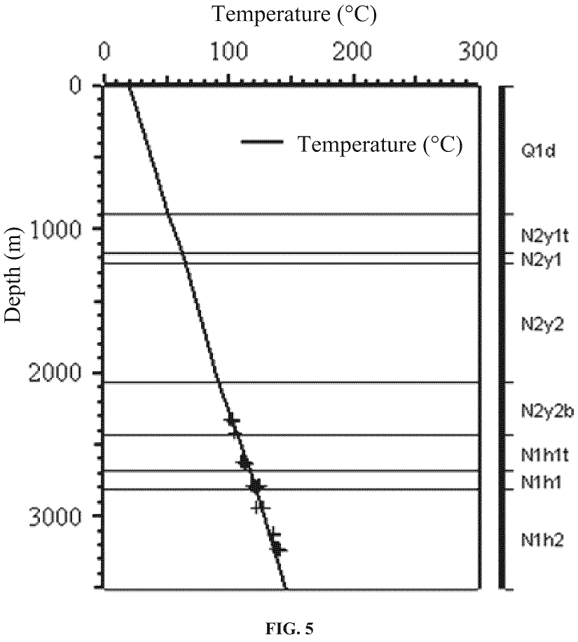

In step 4), thermal history reconstruction S4: the formation temperature data and geothermal gradient data 112 of the sandstone of the target horizon are implanted into the numerical model of pressure simulation to reconstruct the thermal history of the sandstone of the target horizon; and when a simulated formation temperature value is consistent with a measured formation temperature value (FIG. 5), it indicates that the reconstructed thermal history is accurate.

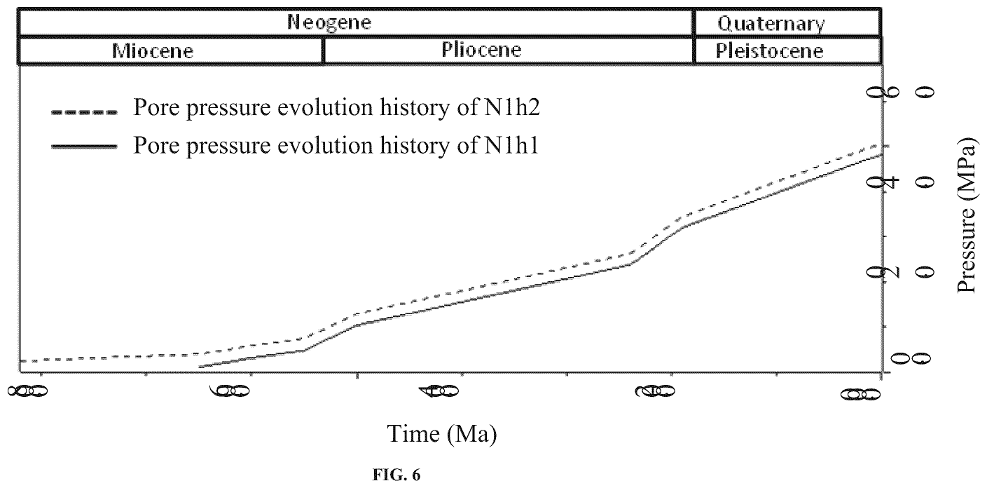

In step 5), an undercompacted pore pressure evolution history is quantitatively simulated (S5): distribution ranges and average values 113 of porosities and permeabilities of the sandstone of the target horizon and an overlying stratum are statistically analyzed based on the conventional core analysis data; the porosity and the permeability of the sandstone of the target horizon are input to the numerical model 114 of pressure simulation to determine the porosity and the permeability of the overlying stratum 115, 116, and the undercompacted pore pressure evolution history is quantitatively simulated (FIG. 6).

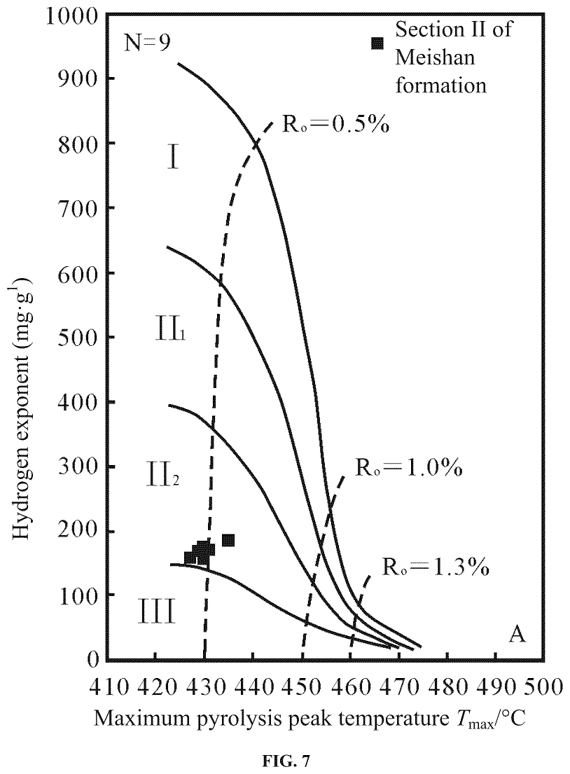

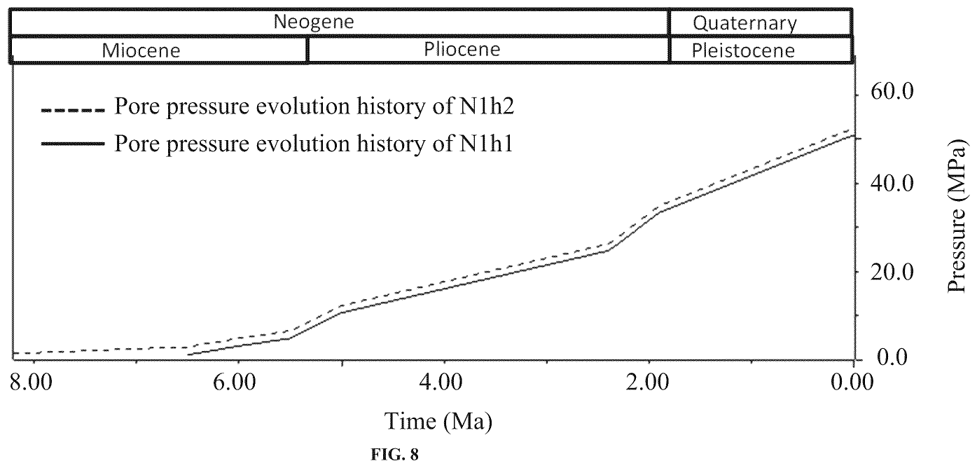

In step 6), an undercompacted and hydrocarbon generation pressurized pore pressure evolution history is quantitatively simulated S6: a kerogen type of underlying hydrocarbon source rock of the sandstone of the target horizon (FIG. 7), and organic carbon and original hydrocarbon generation potentials 117 are investigated based on the organic geochemical data; on the basis of quantitatively simulating the undercompacted pore pressure evolution history, the kerogen type of the underlying hydrocarbon source rock of the sandstone of the target horizon is determined, and an average value of the organic carbon and original hydrocarbon generation potentials and vitrinite reflectance data of the hydrocarbon source rock are input to the numerical model 118 of pressure simulation; and when a simulated vitrinite reflectance value is consistent with a measured vitrinite reflectance data 119, it indicates that the undercompacted and hydrocarbon generation pressurized pore pressure evolution history quantitatively simulated is accurate (FIG. 8).

The kerogen type of the hydrocarbon source rock is determined according to the measured organic geochemical data. Similarly, the data of the organic carbon and original hydrocarbon generation potentials is determined also according to the organic geochemical data.

On the basis of obtaining the undercompacted pore pressure evolution history, in consideration of an overpressure contribution of hydrocarbon generation of the hydrocarbon source rock, the undercompacted and hydrocarbon generation pressurized pore pressure evolution history is quantitatively simulated. The undercompacted pore pressure evolution history and the undercompacted and hydrocarbon generation pressurized pore pressure evolution history are combined to obtain a hydrocarbon generation pressurized pore pressure evolution history.

$${P}_{hydrog} = {P}_{underc + hydrog} - {P}_{underc}$$

where P_{underc+hydrog} refers to an undercompacted and hydrocarbon generation pressurized pore pressure; P_{underc} refers to an undercompacted pore pressure; and P_{hydrog} refers to a hydrocarbon generation pressurized pore pressure.

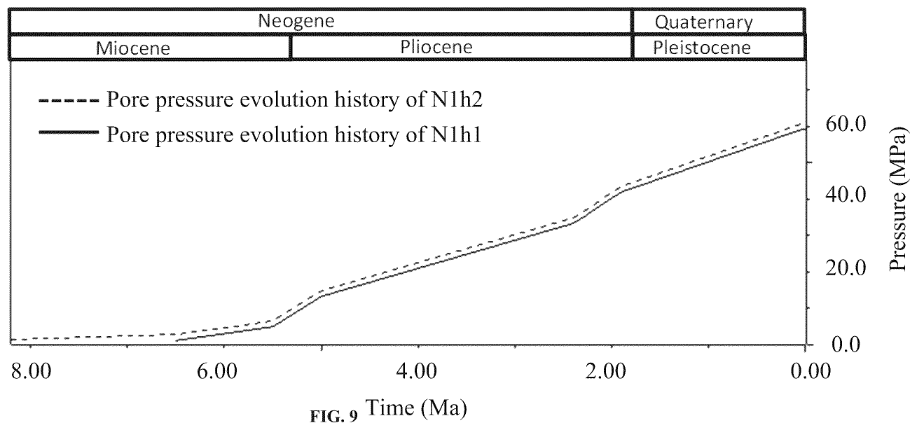

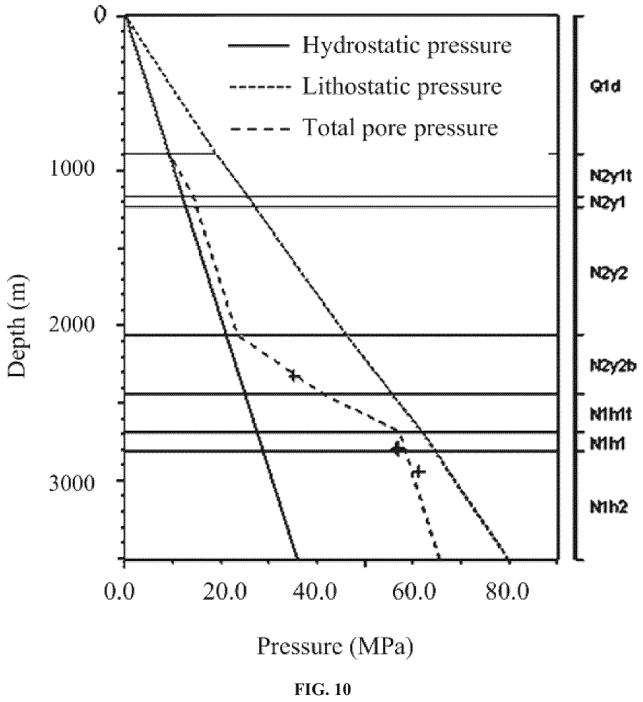

In step 7), a total pore pressure evolution history is quantitatively simulated S7: the formation pressure characteristic 120 of the sandstone of the target horizon is analyzed based on measured formation pressure data; on the basis of quantitatively simulating the undercompacted and hydrocarbon generation pressurized pore pressure evolution history, simulated formation pressure data is corrected with the measured formation pressure data; and when a measured formation pressure value is consistent with a simulated formation pressure value 121, the total pore pressure evolution history is quantitatively simulated. (FIG. 9 and FIG. 10)

On the basis of the undercompacted and hydrocarbon generation pressurized pore pressure evolution history, the simulated formation pressure data is corrected with the measured formation pressure data. When the measured formation pressure value is consistent with the simulated formation pressure value, the total pore pressure evolution history is quantitatively simulated. Therefore, on the basis of the undercompacted and hydrocarbon generation pressurized pore pressure evolution history and the total pore pressure evolution history, a pore pressure of other origin (a third origin) is evaluated.

$${P}_{other} = {P}_{total} - {P}_{underc + hydrog}$$

where P_{underc+hydrog} refers to the undercompacted and hydrocarbon generation pressurized pore pressure; Pₜₒₜₐₗ refers to a total pore pressure; and Pother refers to the pore pressure of other origin (a pore pressure of the third origin).

In step 8), quantitative analysis of contributions of three origin of overpressure is performed S8:

The undercompacted pore pressure evolution history (P_{underc}), the undercompacted and hydrocarbon generation pressurized pore pressure evolution history (P_{hydrog}), and the total pore pressure evolution history (Pₜₒₜₐₗ) are combined; when the total pore pressure evolution history is equal to the undercompacted and hydrocarbon generation pressurized pore pressure evolution history 106, the overpressure in the sandstone of the target horizon is contributed by two origins, namely the undercompaction and the pressurization by hydrocarbon generation 107; the undercompacted pore pressure evolution history and the undercompacted and hydrocarbon generation pressurized pore pressure evolution history are combined to quantitatively analyze contributions of the undercompaction (P_{underc}) and the pressurization by hydrocarbon generation (P_{hydrog}) to total overpressure (Pₜₒₜₐₗ) 122;

$${P}_{total} = {P}_{underc} + {P}_{hydrog}$$

where Pₜₒₜₐₗ refers to the total pore pressure; P_{underc} refers to the undercompacted pore pressure; and P_{hydrog} refers to the hydrocarbon generation pressurized pore pressure;

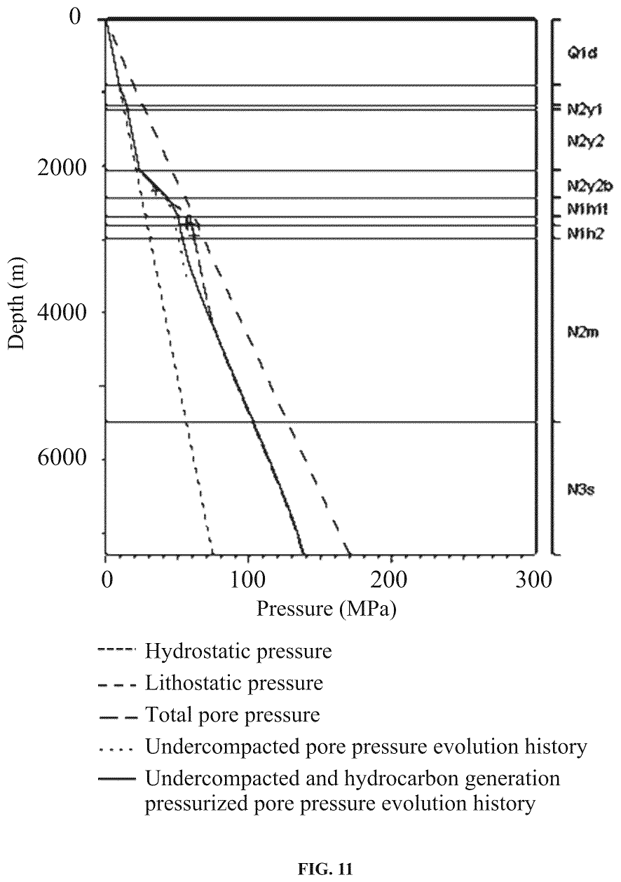

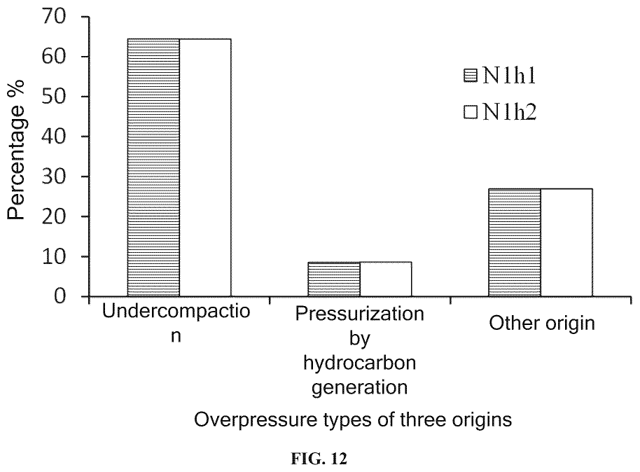

When the total pore pressure evolution history is greater than the undercompacted and hydrocarbon generation pressurized pore pressure evolution history 108, the overpressure in the sandstone of the target horizon is contributed by the undercompaction, the pressurization by hydrocarbon generation, and other origin 109 (FIG. 11); and the undercompacted pore pressure evolution history, the undercompacted and hydrocarbon generation pressurized pore pressure evolution history, and the total pore pressure evolution history are combined to quantitatively analyze contributions of the undercompaction (P_{underc}), the pressurization by hydrocarbon generation (P_{hydrog}), and other origin (Pother) to total overpressure (Pₜₒₜₐₗ) 122 (FIG. 12);

$${P}_{total} = {P}_{underc} + {P}_{hydrog} + {P}_{other}$$

where Pₜₒₜₐₗ refers to the total pore pressure; P_{underc} refers to the undercompacted pore pressure; P_{hydrog} refers to the hydrocarbon generation pressurized pore pressure; and Pother refers to the pore pressure of other origin.

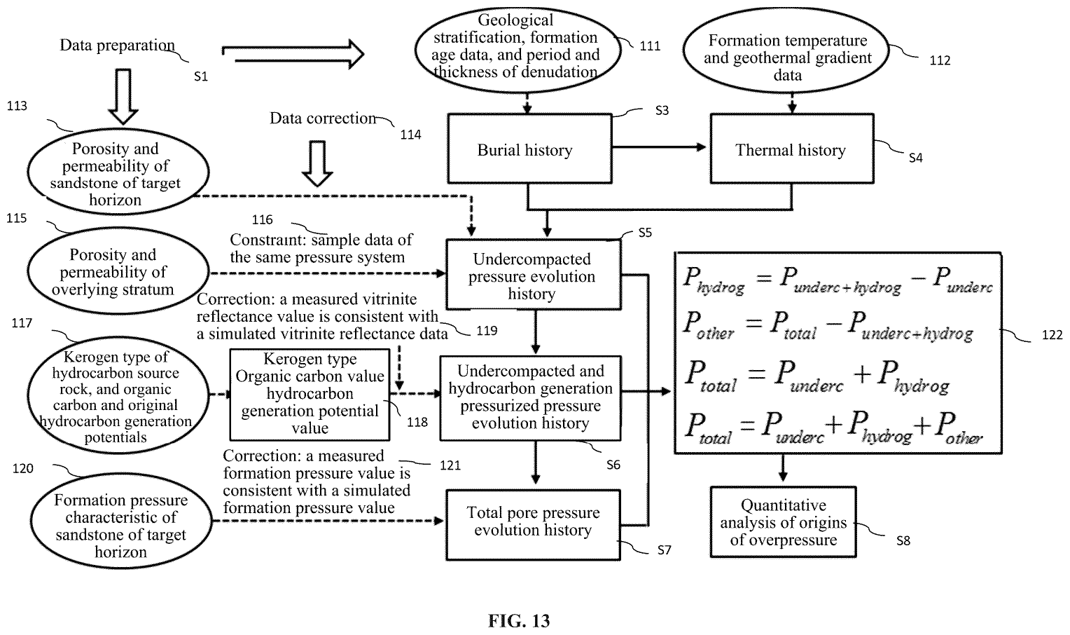

According to the present disclosure, the undercompacted pore pressure evolution history, the undercompacted and hydrocarbon generation pressurized pore pressure evolution history, and the total pore pressure evolution history are combined to quantitatively analyze contributions of origins of abnormal overpressure by the undercompaction, the pressurization by hydrocarbon generation, and other origin (FIG. 13).

The present disclosure quantitatively simulates contributions of three origin of overpressure in sandstone, and quantitatively analyzes contributions of three origins of overpressure. Regional tentonic characteristics, geological data, and seismic data of a research region may be combined to determine a specific origin mechanism of a pore pressure of other origin (the third origin).

### Example 1

The quantitative simulation method for contributions of three origin of overpressure in sandstone includes the following steps.
(1) Taking Huangliu formation of XX region in XX basin as an example, analytical testing data, well logging data, geological data, seismic data, and the like are collected, where the analytical testing data includes conventional core analysis, cast thin section, and scanning electron microscope image data, and organic geochemical data; and the geological data includes well drilling stratification data, formation pressure data, formation temperature data, vitrinite reflectance, and stratigraphic time data. Part of the formation pressure data is shown in Table 1.

TABLE 1
Statistical Table of Formation Pressure Data of Huangliu Formation

| | | | Formation | |
|---|---|---|---|---|
| | Measuring | Formation | Pressure | |
| Well | Point Well | Pressure/ | Coefficient | Formation |
| Name | Depth/m | MPa | g/cc | Temperature/° C. |
| XX1 | 2331 | 34.94 | 1.544 | 102.2 |
| XX1 | 2790 | 56.49 | 2.08 | 119.7 |
| XX1 | 2795.5 | 56.58 | 2.08 | 119.9 |
| XX1 | 2796.5 | 56.61 | | 120.2 |
| XX1 | 2797.5 | 56.59 | 2.08 | 120.5 |
| XX1 | 2806.7 | 56.73 | | 121.3 |
| XX1 | 2807 | 56.73 | | 121.6 |
| XX1 | 2808.5 | 56.66 | | |
| XX1 | 2943.5 | 61.12 | | |
| XX1 | 2790 | 56.44 | | |
| XX1 | 2795.5 | 56.6 | 2.08 | 123.6 |
| XX1 | 2796.3 | 56.64 | | 124.5 |
| XX1 | 2796.8 | 56.63 | | 124.5 |
| XX1 | 2806.3 | 56.75 | | |
| XX1 | 2807 | 56.67 | | |
| XX1 | 2809 | 56.73 | | |
| XX1 | 2790.5 | 56.38 | | 125.4 |
| XX1 | 2791.5 | 56.45 | | |
| XY2 | 3025.3 | 55.68 | 1.89 | 129.4 |
| XY2 | 3060 | 56.18 | 1.89 | 139.8 |
| XY2 | 3028.3 | | 1.9 | 137.4 |
| XY1 | 2995 | 52.76 | 1.81 | 129 |
| XY1 | 2993 | 52.76 | 1.81 | 131.65 |
| XY1 | 2989 | 52.76 | 1.81 | 132.12 |
| XY1 | 2983 | 52.74 | 1.82 | 132 |
| XY1 | 2978 | 52.73 | 1.82 | 133 |
| XY1 | 3090 | 53.23 | 1.77 | 132.1 |
| XY1 | 3088 | 53.21 | 1.77 | 132.2 |
| XY1 | 3080 | 53.11 | 1.77 | 140.2 |
| XY1 | 3077 | 53.13 | 1.77 | 140.32 |
| XY1 | 3074.2 | 53.11 | 1.78 | 140.25 |
| XY1 | 3095 | 53.23 | 1.77 | 140.74 |
| XY1 | 3107 | 53.32 | 1.76 | 141.28 |
| XY1 | 3112 | 53.37 | 1.76 | 141.67 |
| XY1 | 3117 | 53.42 | 1.76 | 142.03 |
| XY1 | 3046.2 | 52.95 | 1.79 | 140.07 |
| XY1 | 3034.8 | 52.95 | 1.79 | 139.15 |
| XY1 | 3029 | 52.9 | 1.79 | 141.01 |

(2) A formation pressure profile is established according to the formation pressure data, and a formation pressure characteristic of sandstone of a target horizon in a target region is analyzed.

FIG. 2 shows a profile of a measured reservoir temperature and depth relationship of sandstone of a target horizon in XX basin. A reservoir temperature of Huangliu formation of XX region is distributed in a range of 100.3° C. to 140.5° C. FIG. 3 shows a profile of a measured formation pressure and depth of sandstone of a target horizon in XX basin. The sandstone reservoir of Huangliu formation has the characteristics of high temperature, high pressure, and undercompaction.
(3) Burial history reconstruction: a 1D burial history of the sandstone of the target horizon is established based on geological stratification, the formation age data, and a period and a thickness of denudation. The burial history can well reflect a burial process and tectonic evolution stages of the sandstone of the target horizon.

FIG. 4 shows a burial history of sandstone of Huangliu formation of XX1 well in XX basin. The burial history of the sandstone of the target horizon can well reflect a sedimentary and burial process of the sandstone of Huangliu formation.
(4) Thermal history reconstruction: on the basis of the accurate burial history, the formation temperature data and geothermal gradient data of the sandstone of the target horizon are implanted into the numerical model to reconstruct the thermal history of the sandstone of the target horizon; and when a simulated formation temperature value is consistent with a measured formation temperature value (FIG. 5), it indicates that the reconstructed thermal history is accurate. FIG. 5 shows a comparison chart of a measured temperature value and a simulated temperature value of sandstone of Huangliu formation of XX1 well in XX basin.
(5) An undercompacted pore pressure evolution history is quantitatively simulated: distribution ranges and average values of porosities and permeabilities of the sandstone of the target horizon and an overlying stratum are statistically analyzed based on the conventional core analysis data. Part of the conventional core analysis data is shown in Table 2. In the numerical model, the porosity and the permeability of the sandstone of the target horizon are then specified in detail, and the porosity and the permeability of the overlying stratum are specified. The undercompacted pore pressure evolution history is quantitatively simulated.

TABLE 2
Statistical Table of Physical Properties of Sandstone of
Target Horizon and Overlying Stratum

| Well | Measuring Point | | |
|---|---|---|---|
| Name | Well Depth/m | Porosity/% | Permeability/mD |
| XX1 | 2329 | 14.3 | 0.24 |
| XX1 | 2330 | 14.3 | 0.24 |
| XX1 | 2331 | 14.3 | 0.24 |
| XX1 | 2332 | 14.3 | 0.24 |
| XX1 | 2334 | 14.4 | 0.25 |
| XX1 | 2334.5 | 14.4 | 0.25 |
| XX1 | 2335 | 14.4 | 0.25 |
| XX1 | 2334.8 | 14.4 | 0.25 |
| XX1 | 2628 | 10.4 | |
| XX1 | 2627.5 | 10.4 | |
| XX1 | 2629 | 10.4 | |
| XX1 | 2630.5 | 10.4 | |
| XX1 | 2633 | 10.2 | |
| XX1 | 2636 | 11 | |
| XX1 | 2789.8 | 16 | 0.52 |
| XX1 | 2790 | 16 | 0.52 |
| XX1 | 2795.5 | 17 | 0.83 |
| XX1 | 2796.5 | 16.4 | 0.63 |
| XX1 | 2797.5 | 16.4 | 0.63 |
| XX1 | 2806.5 | 13.1 | 0.14 |
| XX1 | 2806.7 | 13.1 | 0.14 |
| XX1 | 2807 | 13.1 | 0.14 |
| XX1 | 2808.5 | 14.9 | 0.32 |
| XX1 | 2796.3 | 17 | 0.83 |
| XX1 | 2796.8 | 16.4 | 0.63 |
| XX1 | 2806.3 | 13.1 | 0.14 |
| XX1 | 2807 | 13.1 | 0.14 |
| XX1 | 2809 | 15.4 | 0.4 |
| XX1 | 2790.5 | 16 | 0.52 |
| XX1 | 3232.5 | 15.5 | 0.42 |
| XX1 | 3233 | 15.5 | 0.42 |
| XX1 | 3232.7 | 15.5 | 0.42 |
| XX1 | 3234 | 17.5 | 1.04 |
| XX1 | 3233.5 | 17.5 | 1.04 |
| XX1 | 3235 | 15.4 | 0.4 |
| XX1 | 3236 | 15.4 | 0.4 |
| XX1 | 3235.5 | 15.4 | 0.4 |
| XX1 | 3235.3 | 15.4 | 0.4 |
| XX1 | 3131 | 16.1 | 0.55 |
| XX1 | 3130 | 17.8 | 1.2 |
| XX1 | 3123.8 | 14.5 | 0.26 |

The porosity and the permeability of the sandstone of Huangliu formation and the overlying stratum are specified in detail, and the undercompacted pore pressure evolution history of the sandstone of the target horizon is quantitatively simulated. FIG. 6 shows an undercompacted pore pressure evolution history of sandstone of a target horizon in XX basin.
(6) An undercompacted and hydrocarbon generation pressurized pore pressure evolution history is quantitatively simulated: a kerogen type of underlying hydrocarbon source rock of the sandstone of the target horizon, and organic carbon and original hydrocarbon generation potentials are investigated based on the organic geochemical data. Disclosed and published documents show that: neritic facies mudstone of Miocene Meishan formation and Sanya formation is the most important gas source rock of natural gas reservoirs in XX basin.

FIG. 7 shows a kerogen type of underlying hydrocarbon source rock in XX basin. Marine facies hydrocarbon source rock of medium-good level develops in Miocene Meishan formation and Sanya formation in XX basin. Main organic matter types are type II₂ to type III. Mature hydrocarbon generation thresholds are reached in both formations. The hydrocarbon source rock of Meishan formation is better than that of Sanya formation.

On the basis of the undercompacted pore pressure evolution history, the kerogen type of the underlying hydrocarbon source rock of the sandstone of the target horizon, and the organic carbon and original hydrocarbon generation potentials are then specified in detail, and vitrinite reflectance data of the hydrocarbon source rock is implanted. When a simulated vitrinite reflectance value is consistent with a measured vitrinite reflectance data, it indicates the accuracy of the undercompacted and hydrocarbon generation pressurized pore pressure evolution history quantitatively simulated. FIG. 8 shows an undercompacted and hydrocarbon generation pressurized pore pressure evolution history of sandstone of Huangliu formation of XX1 well in XX basin.
(7) A total pore pressure evolution history is quantitatively simulated: the formation pressure characteristic of the sandstone of the target horizon is analyzed based on measured formation pressure data; on the basis of the undercompacted and hydrocarbon generation pressurized pore pressure evolution history, simulated formation pressure data is corrected with the measured formation pressure data; and when a measured formation pressure value is consistent with a simulated formation pressure value, the total pore pressure evolution history is quantitatively simulated. FIG. 9 shows a total pore pressure evolution history of sandstone of Huangliu formation of XX1 well in XX basin. FIG. 10 shows a comparison chart of measured pressure data and simulated pressure data of sandstone of Huangliu formation of XX1 well in XX basin. Overpressure occurs separately at about 5.2 Ma and 5.3 Ma in Section I and section II of Huangliu formation of XX1 well (with a pressure coefficient of greater than 1.2). With increasing burial depth, the pressure coefficient is increased to 2.05 and 1.97 separately.
(8) Quantitative analysis of contributions of three origin of overpressure is performed: the undercompacted pore pressure evolution history, the undercompacted and hydrocarbon generation pressurized pore pressure evolution history, and the total pore pressure evolution history are combined; when the total pore pressure evolution history is greater than the undercompacted and hydrocarbon generation pressurized pore pressure evolution history, the overpressure in the sandstone of the target horizon is contributed by three origins, namely undercompaction, pressurization by hydrocarbon generation, and other origin; and the undercompacted pore pressure evolution history, the undercompacted and hydrocarbon generation pressurized pore pressure evolution history, and the total pore pressure evolution history are combined to quantitatively analyze contributions of the undercompaction, the pressurization by hydrocarbon generation, and other origin to total overpressure.

FIG. 11 shows a comparison chart of three origins of overpressure. FIG. 12 shows a histogram of contribution ratios of three origins of overpressure to overpressure in sandstone. The overpressure in sandstone of Huangliu formation of XX1 well is mainly composed of undercompaction, pressurization by hydrocarbon generation, montmorillonite-illite transition, and overpressure transfer.

What is claimed is:

1. A quantitative simulation method for contributions of three origin of overpressure in sandstone, comprising:
collecting analytical testing data, well logging data, geological data, and seismic data of sandstone of a target horizon, wherein the analytical testing data comprises conventional core analysis, cast thin section, and scanning electron microscope image data, and organic geochemical data; and the geological data comprises well drilling stratification data, formation pressure data, formation temperature data, vitrinite reflectance data, and formation age data;
establishing a formation pressure profile according to the formation pressure data, analyzing a formation pressure characteristic of the sandstone of the target horizon in a target region, and establishing a numerical model of pressure simulation, wherein the numerical model of pressure simulation is established based on an actual formation characteristic and actual geological data of the target horizon and relates to a burial history, a thermal history, and a pressure history;
burial history reconstruction: establishing a one-dimensional burial history of the sandstone of the target horizon based on geological stratification, the formation age data, and a period and a thickness of denudation;
thermal history reconstruction: implanting the formation temperature data and geothermal gradient data of the sandstone of the target horizon into the numerical model of pressure simulation to reconstruct the thermal history of the sandstone of the target horizon; and when a simulated formation temperature value is consistent with a measured formation temperature value, indicating that the reconstructed thermal history is accurate;
quantitatively simulating an undercompacted pore pressure evolution history;
quantitatively simulating an undercompacted and hydrocarbon generation pressurized pore pressure evolution history;
quantitatively simulating a total pore pressure evolution history;
quantitative analysis of contributions of three origin of overpressure: when the total pore pressure evolution history is greater than the undercompacted and hydrocarbon generation pressurized pore pressure evolution history, the overpressure in the sandstone of the target horizon being contributed by undercompaction, pressurization by hydrocarbon generation, and a third origin, and quantitatively analyzing contributions of the undercompaction, the pressurization by hydrocarbon generation, and the third origin to total overpressure; and when the total pore pressure evolution history is equal to the undercompacted and hydrocarbon generation pressurized pore pressure evolution history, the overpressure in the sandstone of the target horizon being contributed by two origins, namely undercompaction and pressurization by hydrocarbon generation, and quantitatively analyzing contributions of the undercompaction and the pressurization by hydrocarbon generation to total overpressure; and
determining an exploration region of an oil and gas reservoir according to the origins of overpressure, which specifically comprises:
when the undercompaction is a dominant origin of overpressure, representing that an overpressured reservoir has an obvious water-bearing characteristic; and
when the undercompaction and the pressurization by hydrocarbon generation are dominant origins of overpressure, representing that the overpressured reservoir has an obvious gas-bearing characteristic, wherein natural gas exploration in the reservoir is concentrated in a moderately overpressured region and a region having a high gas saturation and having a fault, a crack, and matrix pores; and reserves of natural gas are low in regions having lowest overpressure and highest overpressure.

2. The quantitative simulation method for contributions of three origin of overpressure in sandstone according to claim 1, wherein the quantitatively simulating an undercompacted pore pressure evolution history comprises:
statistically analyzing distribution ranges and average values of porosities and permeabilities of the sandstone of the target horizon and an overlying stratum based on the conventional core analysis data;
inputting the porosity and the permeability of the sandstone of the target horizon to the numerical model of pressure simulation to determine the porosity and the permeability of the overlying stratum, and
quantitatively simulating the undercompacted pore pressure evolution history.

3. The quantitative simulation method for contributions of three origin of overpressure in sandstone according to claim 1, wherein the quantitatively simulating an undercompacted pore pressure evolution history comprises:
determining a petroleum system in which the sandstone of the target horizon is located according to the burial history and the thermal history of the sandstone of the target horizon, wherein the petroleum system comprises hydrocarbon source rock, a reservoir stratum, and an overlying stratum; and
subtly plotting a porosity-depth relationship plate and a porosity-permeability relationship plate of the sandstone of the target horizon and a plurality of overlying strata, and implanting the two plates into the numerical model of pressure simulation as constraint conditions to quantitatively simulate the undercompacted pore pressure evolution history of the sandstone of the target horizon.

4. The quantitative simulation method for contributions of three origin of overpressure in sandstone according to claim 2, wherein the quantitatively simulating an undercompacted and hydrocarbon generation pressurized pore pressure evolution history comprises:
investigating a kerogen type of underlying hydrocarbon source rock of the sandstone of the target horizon, and organic carbon and original hydrocarbon generation potentials based on the organic geochemical data;
on the basis of quantitatively simulating the undercompacted pore pressure evolution history, determining the kerogen type of the underlying hydrocarbon source rock of the sandstone of the target horizon, and inputting an average value of the organic carbon and original hydrocarbon generation potentials and vitrinite reflectance data of the hydrocarbon source rock to the numerical model of pressure simulation;
when a simulated vitrinite reflectance value is consistent with a measured vitrinite reflectance data, indicating that the undercompacted and hydrocarbon generation pressurized pore pressure evolution history quantitatively simulated is accurate; and
combining the undercompacted pore pressure evolution history and the undercompacted and hydrocarbon generation pressurized pore pressure evolution history to obtain a hydrocarbon generation pressurized pore pressure evolution history;
$${P}_{hydrog} = {P}_{underc + hydrog} - {P}_{underc}$$
wherein P_{underc+hydrog} refers to an undercompacted and hydrocarbon generation pressurized pore pressure; P_{underc} refers to an undercompacted pore pressure; and P_{hydrog} refers to a hydrocarbon generation pressurized pore pressure.

5. The quantitative simulation method for contributions of three origin of overpressure in sandstone according to claim 4, wherein the quantitatively simulating a total pore pressure evolution history comprises:
analyzing the formation pressure characteristic of the sandstone of the target horizon based on measured formation pressure data; on the basis of quantitatively simulating the undercompacted and hydrocarbon generation pressurized pore pressure evolution history, correcting simulated formation pressure data with the measured formation pressure data;
when a measured formation pressure value is consistent with a simulated formation pressure value, quantitatively simulating the total pore pressure evolution history; and
evaluating a pore pressure of other origin based on the undercompacted and hydrocarbon generation pressurized pore pressure evolution history and the total pore pressure evolution history;
$${P}_{other} = {P}_{total} - {P}_{underc + hydrog}$$
wherein P_{underc+hydrog} refers to the undercompacted and hydrocarbon generation pressurized pore pressure; Pₜₒₜₐₗ refers to a total pore pressure; and Pother refers to the pore pressure of other origin.

6. The quantitative simulation method for contributions of three origin of overpressure in sandstone according to claim 5, wherein the quantitative analysis of contributions of three origin of overpressure comprises:
the undercompacted pore pressure evolution history (P_{underc}), the undercompacted and hydrocarbon generation pressurized pore pressure evolution history (P_{hydrog}), and the total pore pressure evolution history (Pₜₒₜₐₗ) are combined;
when the total pore pressure evolution history is equal to the undercompacted and hydrocarbon generation pressurized pore pressure evolution history, the overpressure in the sandstone of the target horizon is contributed by two origins, namely the undercompaction and the pressurization by hydrocarbon generation; the undercompacted pore pressure evolution history and the undercompacted and hydrocarbon generation pressurized pore pressure evolution history are combined to quantitatively analyze contributions of the undercompaction (P_{underc}) and the pressurization by hydrocarbon generation (P_{hydrog}) to the total overpressure (Pₜₒₜₐₗ);
$${P}_{total} = {P}_{underc} + {P}_{hydrog}$$
wherein Pₜₒₜₐₗ refers to the total pore pressure; P_{underc} refers to the undercompacted pore pressure; and P_{hydrog} refers to the hydrocarbon generation pressurized pore pressure;
when the total pore pressure evolution history is greater than the undercompacted and hydrocarbon generation pressurized pore pressure evolution history, the overpressure in the sandstone of the target horizon is contributed by the undercompaction, the pressurization by hydrocarbon generation, and other origin; and the undercompacted pore pressure evolution history, the undercompacted and hydrocarbon generation pressurized pore pressure evolution history, and the total pore pressure evolution history are combined to quantitatively analyze contributions of the undercompaction (P_{underc}), the pressurization by hydrocarbon generation (P_{hydrog}), and other origin (Pother) to the total overpressure (Pₜₒₜₐₗ);
$${P}_{total} = {P}_{underc} + {P}_{hydrog} + {P}_{other}$$
wherein Pₜₒₜₐₗ refers to the total pore pressure; P_{underc} refers to the undercompacted pore pressure; P_{hydrog} refers to the hydrocarbon generation pressurized pore pressure; and Pother refers to the pore pressure of other origin.

7. The quantitative simulation method for contributions of three origin of overpressure in sandstone according to claim 3, wherein the quantitatively simulating an undercompacted and hydrocarbon generation pressurized pore pressure evolution history comprises:
investigating a kerogen type of underlying hydrocarbon source rock of the sandstone of the target horizon, and organic carbon and original hydrocarbon generation potentials based on the organic geochemical data;
on the basis of quantitatively simulating the undercompacted pore pressure evolution history, determining the kerogen type of the underlying hydrocarbon source rock of the sandstone of the target horizon, and inputting an average value of the organic carbon and original hydrocarbon generation potentials and vitrinite reflectance data of the hydrocarbon source rock to the numerical model of pressure simulation;
when a simulated vitrinite reflectance value is consistent with a measured vitrinite reflectance data, indicating that the undercompacted and hydrocarbon generation pressurized pore pressure evolution history quantitatively simulated is accurate; and
combining the undercompacted pore pressure evolution history and the undercompacted and hydrocarbon generation pressurized pore pressure evolution history to obtain a hydrocarbon generation pressurized pore pressure evolution history;
$${P}_{hydrog} = {P}_{underc + hydrog} - {P}_{underc}$$
wherein P_{underc+hydrog} refers to an undercompacted and hydrocarbon generation pressurized pore pressure; P_{underc} refers to an undercompacted pore pressure; and P_{hydrog} refers to a hydrocarbon generation pressurized pore pressure.

8. The quantitative simulation method for contributions of three origin of overpressure in sandstone according to claim 7, wherein the quantitatively simulating a total pore pressure evolution history comprises:
analyzing the formation pressure characteristic of the sandstone of the target horizon based on measured formation pressure data; on the basis of quantitatively simulating the undercompacted and hydrocarbon generation pressurized pore pressure evolution history, correcting simulated formation pressure data with the measured formation pressure data;
when a measured formation pressure value is consistent with a simulated formation pressure value, quantitatively simulating the total pore pressure evolution history; and
evaluating a pore pressure of other origin based on the undercompacted and hydrocarbon generation pressurized pore pressure evolution history and the total pore pressure evolution history;
$${P}_{other} = {P}_{total} - {P}_{underc + hydrog}$$
wherein P_{underc+hydrog} refers to the undercompacted and hydrocarbon generation pressurized pore pressure; Pₜₒₜₐₗ refers to a total pore pressure; and Pother refers to the pore pressure of other origin.

9. The quantitative simulation method for contributions of three origin of overpressure in sandstone according to claim 8, wherein the quantitative analysis of contributions of three origin of overpressure comprises:
the undercompacted pore pressure evolution history (P_{underc}), the undercompacted and hydrocarbon generation pressurized pore pressure evolution history (P_{hydrog}), and the total pore pressure evolution history (Pₜₒₜₐₗ) are combined; when the total pore pressure evolution history is equal to the undercompacted and hydrocarbon generation pressurized pore pressure evolution history, the overpressure in the sandstone of the target horizon is contributed by two origins, namely the undercompaction and the pressurization by hydrocarbon generation; the undercompacted pore pressure evolution history and the undercompacted and hydrocarbon generation pressurized pore pressure evolution history are combined to quantitatively analyze contributions of the undercompaction (P_{underc}) and the pressurization by hydrocarbon generation (P_{hydrog}) to the total overpressure (Pₜₒₜₐₗ);
$${P}_{total} = {P}_{underc} + {P}_{hydrog}$$
wherein Pₜₒₜₐₗ refers to the total pore pressure; P_{underc} refers to the undercompacted pore pressure; and P_{hydrog} refers to the hydrocarbon generation pressurized pore pressure;
when the total pore pressure evolution history is greater than the undercompacted and hydrocarbon generation pressurized pore pressure evolution history, the overpressure in the sandstone of the target horizon is contributed by the undercompaction, the pressurization by hydrocarbon generation, and other origin; and the undercompacted pore pressure evolution history, the undercompacted and hydrocarbon generation pressurized pore pressure evolution history, and the total pore pressure evolution history are combined to quantitatively analyze contributions of the undercompaction (P_{underc}), the pressurization by hydrocarbon generation (P_{hydrog}), and other origin (Pother) to the total overpressure (Pₜₒₜₐₗ);
$${P}_{total} = {P}_{underc} + {P}_{hydrog} + {P}_{other}$$
wherein Pₜₒₜₐₗ refers to the total pore pressure; P_{underc} refers to the undercompacted pore pressure; P_{hydrog} refers to the hydrocarbon generation pressurized pore pressure; and Pother refers to the pore pressure of other origin.
